(19) United States
(12) Patent Application Publication
(10) Pub. No.: US 2026/0233130 A1
(43) Pub. Date: Aug. 13, 2026

(54) SYSTEMS FOR DETECTION OF BYPASS VALVE ACTUATION USING PRESSURE DATA

(71) Applicant: Donaldson Company, Inc., Bloomington, MN (US)

(72) Inventors: Michael J. Cronin, Apple Valley, MN (US); Michael J. Gustafson, Minnetonka, MN (US); Yves S. Ilboudo, Crystal, MN (US)

(21) Appl. No.: 19/153,866

(22) PCT Filed: Feb. 7, 2024
(86) PCT No.: PCT/US2024/014876

§ 371 Date: Aug. 5, 2025

Related U.S. Application Data
(60) Provisional application No. 63/443,856, filed on Feb. 7, 2023.

(51) Int. Cl. B01D 27/10; F15B 19/00

(52) U.S. Cl. CPC B01D 27/101; B01D 27/103; F15B 19/005; F15B 2211/615; F15B 2211/6306

(57) ABSTRACT

Embodiments herein relate to systems and methods for monitoring bypass valves of a filtration system. In an embodiment, a bypass valve monitoring system is included having a control circuit and a sensing unit wherein the sensing unit generates a signal reflecting high speed pressure and a signal reflecting filter restriction pressure. The bypass valve monitoring system can identify patterns in the signal reflecting high speed pressure associated with filter restriction pressure levels indicating a position of the bypass valve. In an embodiment, the sensing unit generates a signal reflecting acoustics and/or vibrations and a signal reflecting strain and the system is configured to identify patterns associated with the signal reflecting acoustics and/or vibrations reflecting valve chatter and then use correlated values of strain from the signal reflecting strain to determine a bypass valve opening state. Other embodiments are also included herein.

This application is being filed as a PCT International Patent application on Feb. 7, 2024, in the name of Donaldson Company, Inc., a U.S. national corporation, applicant for the designation of all countries, and Michael J. Cronin, a Citizen of the U.S., and Michael J. Gustafson, a Citizen of the U.S., and Yves S. Ilboudo, a Citizen of the U.S., inventors for the designation all countries, and claims priority to U.S. Provisional Patent Application No. 63/443,856, filed Feb. 7, 2023, the contents of which are herein incorporated by reference in its entirety.

### FIELD

Embodiments herein relate to systems and methods for monitoring bypass valves of a filtration system.

### BACKGROUND

Filtration systems sometimes include a valve, known as a bypass valve, that is in parallel with a filtration element, filtration housing, and/or portion thereof (filtration component) and allows the fluid being filtered to bypass the filtration component under certain circumstances. For example, if filter restriction rises to a certain level, such as due to filter loading, then the bypass valve opens allowing a fluid to bypass the filtration component to allow for continued sufficient fluid flow.

### SUMMARY

Embodiments herein relate to systems and methods for monitoring bypass valves of a filtration system. In a first aspect, a bypass valve monitoring system is included having a control circuit, and a sensing unit, wherein the sensing unit generates a signal reflecting high speed pressure and a signal reflecting filter restriction pressure. The sensing unit can be in electronic communication with the control circuit and the bypass valve monitoring system can be configured to record signals from the sensing unit and identify patterns in the signal reflecting high speed pressure associated with filter restriction pressure levels indicating a position of the bypass valve.

In a second aspect, in addition to one or more of the preceding or following aspects, or in the alternative to some aspects, the position of the bypass valve can include at least one selected from the group consisting of fully open, partially open, and fully closed.

In a third aspect, in addition to one or more of the preceding or following aspects, or in the alternative to some aspects, the bypass valve monitoring system can be configured to identify changes in patterns of the signal reflecting high speed pressure associated with filter restriction pressure changes.

In a fourth aspect, in addition to one or more of the preceding or following aspects, or in the alternative to some aspects, the bypass valve monitoring system can be configured to identify changes in patterns of the signal reflecting high speed pressure associated with filter restriction pressure increases, wherein such changes indicate that a bypass valve has at least partially opened.

In a fifth aspect, in addition to one or more of the preceding or following aspects, or in the alternative to some aspects, the patterns can include frequency patterns.

In a sixth aspect, in addition to one or more of the preceding or following aspects, or in the alternative to some aspects, the patterns can include a multi-band frequency pattern.

In a seventh aspect, in addition to one or more of the preceding or following aspects, or in the alternative to some aspects, the bypass valve monitoring system can be configured to determine valve opening pressure.

In an eighth aspect, in addition to one or more of the preceding or following aspects, or in the alternative to some aspects, the bypass valve monitoring system can be configured to determine that the bypass valve is operating in a bypass mode when the filter restriction pressure is above the determined valve opening pressure.

In a ninth aspect, in addition to one or more of the preceding or following aspects, or in the alternative to some aspects, the bypass valve monitoring system can be configured to track changes in valve opening pressure over time.

In a tenth aspect, in addition to one or more of the preceding or following aspects, or in the alternative to some aspects, the bypass valve monitoring system can be configured to determine valve opening pressure based on a filter restriction pressure at a time of detected valve opening.

In an eleventh aspect, in addition to one or more of the preceding or following aspects, or in the alternative to some aspects, the bypass valve monitoring system can be configured to estimate filter remaining useful life based on an amount of time that the bypass valve is in an open position.

In a twelfth aspect, in addition to one or more of the preceding or following aspects, or in the alternative to some aspects, can further include a temperature sensor, wherein the temperature sensor can be in electronic communication with the control circuit and/or wherein the bypass valve monitoring system is configured to receive signals reflecting temperature.

In a thirteenth aspect, in addition to one or more of the preceding or following aspects, or in the alternative to some aspects, the bypass valve monitoring system can be configured to distinguish between cold start bypass events and normal operation bypass events based at least in part on a signal from the temperature sensor or a received signal reflecting temperature.

In a fourteenth aspect, in addition to one or more of the preceding or following aspects, or in the alternative to some aspects, the bypass valve monitoring system can be configured to utilize signals from a cold start bypass to train the system to detect valve bypass events.

In a fifteenth aspect, in addition to one or more of the preceding or following aspects, or in the alternative to some aspects, the bypass valve monitoring system can be configured to estimate filter remaining useful life based on normal operation bypass events.

In a sixteenth aspect, in addition to one or more of the preceding or following aspects, or in the alternative to some aspects, the bypass valve monitoring system can be configured to estimate filter remaining useful life based on detected valve opening events.

In a seventeenth aspect, in addition to one or more of the preceding or following aspects, or in the alternative to some aspects, the sensing unit includes a pressure sensor generating both the signal reflecting high speed pressure and the signal reflecting filter restriction pressure.

In an eighteenth aspect, in addition to one or more of the preceding or following aspects, or in the alternative to some aspects, wherein at least a portion of the sensing unit can be configured to be in direct contact with a fluid inside a fluid line.

In a nineteenth aspect, in addition to one or more of the preceding or following aspects, or in the alternative to some aspects, the sensing unit can be configured to be mounted on a fluid line, but not in direct contact with a fluid inside the fluid line.

In a twentieth aspect, in addition to one or more of the preceding or following aspects, or in the alternative to some aspects, the sensing unit can be configured to be wrapped around a fluid line.

In a twenty-first aspect, in addition to one or more of the preceding or following aspects, or in the alternative to some aspects, the sensing unit can include a flexible substrate.

In a twenty-second aspect, in addition to one or more of the preceding or following aspects, or in the alternative to some aspects, the sensing unit can further include two or more sensing elements, wherein the two or more sensing elements can be disposed on the flexible substrate.

In a twenty-third aspect, in addition to one or more of the preceding or following aspects, or in the alternative to some aspects, the two or more sensing elements can be positioned to be at different axial and/or radial positions along a fluid line.

In a twenty-fourth aspect, in addition to one or more of the preceding or following aspects, or in the alternative to some aspects, the sensing unit can include a first sensor, wherein the first sensor generates the signal reflecting high speed pressure, and a second sensor, wherein the second sensor generates the signal reflecting filter restriction pressure.

In a twenty-fifth aspect, in addition to one or more of the preceding or following aspects, or in the alternative to some aspects, the first sensor can include a pressure sensor, wherein the pressure sensor can have a sampling rate of at least 8,000 Hz.

In a twenty-sixth aspect, in addition to one or more of the preceding or following aspects, or in the alternative to some aspects, the first sensor can include a microphone.

In a twenty-seventh aspect, in addition to one or more of the preceding or following aspects, or in the alternative to some aspects, the second sensor can include a differential pressure sensor.

In a twenty-eighth aspect, in addition to one or more of the preceding or following aspects, or in the alternative to some aspects, the second sensor can include a first pressure sensing element located on one side of a filter element and a second pressure sensing element located on the other side of the filter element.

In a twenty-ninth aspect, in addition to one or more of the preceding or following aspects, or in the alternative to some aspects, the second sensor can include a first pressure sensing element located upstream of a filter element and a second pressure sensing element located downstream of the filter element.

In a thirtieth aspect, in addition to one or more of the preceding or following aspects, or in the alternative to some aspects, the bypass valve monitoring system can be a liquid filtration bypass valve monitoring system.

In a thirty-first aspect, in addition to one or more of the preceding or following aspects, or in the alternative to some aspects, the bypass valve monitoring system can be a hydraulic fluid filtration bypass valve monitoring system.

In a thirty-second aspect, in addition to one or more of the preceding or following aspects, or in the alternative to some aspects, the bypass valve monitoring system can be a gas filtration bypass valve monitoring system.

In a thirty-third aspect, in addition to one or more of the preceding or following aspects, or in the alternative to some aspects, the bypass valve monitoring system can be an air filtration bypass valve monitoring system.

In a thirty-fourth aspect, a method of detecting bypass valve opening can be included. The method can include recording signals from a sensing unit, the signals can include a signal reflecting high speed pressure, and a signal reflecting filter restriction pressure. The method can further include identifying patterns associated with filter restriction pressure levels indicating a position of the bypass valve.

In a thirty-fifth aspect, in addition to one or more of the preceding or following aspects, or in the alternative to some aspects, the method can further include identifying changes in signal patterns of the signal reflecting high speed pressure associated with filter restriction pressure changes.

In a thirty-sixth aspect, in addition to one or more of the preceding or following aspects, or in the alternative to some aspects, the method can further include identifying changes in signal patterns of the signal reflecting high speed pressure associated with filter restriction pressure increases, wherein such changes indicate that a bypass valve can have at least partially opened.

In a thirty-seventh aspect, in addition to one or more of the preceding or following aspects, or in the alternative to some aspects, the method can further include determining valve opening pressure.

In a thirty-eighth aspect, in addition to one or more of the preceding or following aspects, or in the alternative to some aspects, the method can further include determining that the bypass valve can be operating in a bypass mode when the filter restriction pressure can be above the determined valve opening pressure.

In a thirty-ninth aspect, in addition to one or more of the preceding or following aspects, or in the alternative to some aspects, the method can further include tracking changes in valve opening pressure over time.

In a fortieth aspect, in addition to one or more of the preceding or following aspects, or in the alternative to some aspects, the method can further include determining valve opening pressure based on a filter restriction pressure at a time of detected valve opening.

In a forty-first aspect, in addition to one or more of the preceding or following aspects, or in the alternative to some aspects, the method can further include distinguishing between a cold start bypass event and a normal operation bypass event based at least in part on a signal from a temperature sensor.

In a forty-second aspect, in addition to one or more of the preceding or following aspects, or in the alternative to some aspects, the method can further include estimating filter remaining useful life based on detected normal operation bypass events.

In a forty-third aspect, in addition to one or more of the preceding or following aspects, or in the alternative to some aspects, the method can further include estimating filter remaining useful life based on an amount of time that the bypass valve can be in an open position during normal operation bypass events.

In a forty-fourth aspect, in addition to one or more of the preceding or following aspects, or in the alternative to some aspects, the method can further include utilizing signals from a cold start bypass to train the system to detect a valve bypass event.

In a forty-fifth aspect, a bypass valve monitoring system can be included having a control circuit, a first pressure sensor, wherein the first pressure sensor can be in electronic communication with the control circuit, and a second pressure sensor, wherein the second pressure sensor can be in electronic communication with the control circuit. The second pressure sensor can be disposed on an opposite flow side of the valve being monitored from the first pressure sensor. The bypass valve monitoring system can be configured to evaluate a time domain differential pressure based on signals of the two pressure sensors and identify patterns in the time domain differential pressure indicating that a bypass valve can have at least partially opened.

In a forty-sixth aspect, in addition to one or more of the preceding or following aspects, or in the alternative to some aspects, the bypass valve monitoring system can be configured to identify patterns in the time domain differential pressure associated with pressure changes indicating that a bypass valve can be at least partially open.

In a forty-seventh aspect, in addition to one or more of the preceding or following aspects, or in the alternative to some aspects, the bypass valve monitoring system can be configured to identify changes in time domain differential pressure signal patterns occurring as differential pressure increases, wherein such changes indicate that a bypass valve can have at least partially opened.

In a forty-eighth aspect, in addition to one or more of the preceding or following aspects, or in the alternative to some aspects, the patterns can include frequency domain patterns.

In a forty-ninth aspect, in addition to one or more of the preceding or following aspects, or in the alternative to some aspects, the bypass valve monitoring system can be configured to estimate bypass valve opening pressure.

In a fiftieth aspect, in addition to one or more of the preceding or following aspects, or in the alternative to some aspects, the system can further include a temperature sensor, wherein the temperature sensor can be in electronic communication with the control circuit and/or wherein the bypass valve monitoring system can be configured to receive a signal reflecting temperature.

In a fifty-first aspect, in addition to one or more of the preceding or following aspects, or in the alternative to some aspects, the bypass valve monitoring system can be configured to distinguish between cold start bypass events and normal operation bypass events based at least in part on a signal from the temperature sensor or a received signal reflecting temperature.

In a fifty-second aspect, in addition to one or more of the preceding or following aspects, or in the alternative to some aspects, the control circuit can be configured to utilize signals from a cold start bypass event to train the system to detect a valve bypass event.

In a fifty-third aspect, in addition to one or more of the preceding or following aspects, or in the alternative to some aspects, the bypass valve monitoring system can be configured to estimate filter remaining useful life based on normal operation bypass events.

In a fifty-fourth aspect, in addition to one or more of the preceding or following aspects, or in the alternative to some aspects, the bypass valve monitoring system can be configured to estimate filter remaining useful life based on an amount of time that the bypass valve can be in an open position during normal operation bypass events.

In a fifty-fifth aspect, in addition to one or more of the preceding or following aspects, or in the alternative to some aspects, the first pressure sensor can have a sampling rate of at least 8,000 Hz.

In a fifty-sixth aspect, in addition to one or more of the preceding or following aspects, or in the alternative to some aspects, the second pressure sensor can have a sampling rate of at least 8,000 Hz.

In a fifty-seventh aspect, in addition to one or more of the preceding or following aspects, or in the alternative to some aspects, wherein at least a portion of the first pressure sensor or the second pressure sensor can be configured to be in direct contact with a fluid inside a fluid line.

In a fifty-eighth aspect, in addition to one or more of the preceding or following aspects, or in the alternative to some aspects, the first pressure sensor and the second pressure sensor can be configured to be mounted on a fluid line, but not in direct contact with a fluid inside the fluid line.

In a fifty-ninth aspect, in addition to one or more of the preceding or following aspects, or in the alternative to some aspects, the first pressure sensor and the second pressure sensor can be configured to be mounted on flexible substrates and wrapped around a fluid line.

In a sixtieth aspect, a bypass valve monitoring system can be included having a control circuit, and a sensing unit, wherein the sensing unit can be in electronic communication with the control circuit, wherein the sensing unit generates a signal reflecting acoustics and/or vibrations and a signal reflecting strain, wherein the bypass valve monitoring system can be configured to record signals from the sensing unit, and identify patterns associated with the signal reflecting acoustics and/or vibrations reflecting valve chatter and then use correlated values of strain from the signal reflecting strain to determine a bypass valve opening state.

In a sixty-first aspect, in addition to one or more of the preceding or following aspects, or in the alternative to some aspects, the bypass valve monitoring system can be configured to identify patterns of the signal reflecting acoustics and/or vibrations indicating valve chatter associated with strain changes.

In a sixty-second aspect, in addition to one or more of the preceding or following aspects, or in the alternative to some aspects, the bypass valve monitoring system can be configured to identify patterns of the signal reflecting acoustics and/or vibrations indicating valve chatter associated with strain increases, wherein such occurrences indicate that a bypass valve can have at least partially opened.

In a sixty-third aspect, in addition to one or more of the preceding or following aspects, or in the alternative to some aspects, the bypass valve monitoring system can be configured to estimate filter remaining useful life based on an amount of time that the bypass valve can be in an open position.

In a sixty-fourth aspect, in addition to one or more of the preceding or following aspects, or in the alternative to some aspects, the sensing unit can include a temperature sensor, wherein the temperature sensor can be in electronic communication with the control circuit and/or wherein the bypass valve monitoring system can be configured to receive signals reflecting temperature.

In a sixty-fifth aspect, in addition to one or more of the preceding or following aspects, or in the alternative to some aspects, the bypass valve monitoring system can be configured to distinguish between cold start bypass events and normal operation bypass events based at least in part on a signal from the temperature sensor or a received signal reflecting temperature.

In a sixty-sixth aspect, in addition to one or more of the preceding or following aspects, or in the alternative to some aspects, the bypass valve monitoring system can be configured to estimate filter remaining useful life based on normal operation bypass events.

In a sixty-seventh aspect, in addition to one or more of the preceding or following aspects, or in the alternative to some aspects, the bypass valve monitoring system can be configured to estimate filter remaining useful life based on detected valve opening events.

In a sixty-eighth aspect, in addition to one or more of the preceding or following aspects, or in the alternative to some aspects, the sensing unit includes a strain sensing element generating the signal reflecting strain.

In a sixty-ninth aspect, in addition to one or more of the preceding or following aspects, or in the alternative to some aspects, the sensing unit includes a strain sensing element generating both the signal reflecting strain and the signal reflecting acoustics and/or vibrations.

In a seventieth aspect, in addition to one or more of the preceding or following aspects, or in the alternative to some aspects, the sensing unit includes a first strain sensing element and a second strain sensing element generating the signal reflecting strain.

In a seventy-first aspect, in addition to one or more of the preceding or following aspects, or in the alternative to some aspects, the signal reflecting strain reflects differential strain at two points along a fluid line.

In a seventy-second aspect, in addition to one or more of the preceding or following aspects, or in the alternative to some aspects, the sensing unit includes an acoustic and/or vibration sensing element generating the signal reflecting acoustics and/or vibrations.

In a seventy-third aspect, in addition to one or more of the preceding or following aspects, or in the alternative to some aspects, wherein at least a portion of the sensing unit can be configured to be in direct contact with a fluid inside a fluid line.

In a seventy-fourth aspect, in addition to one or more of the preceding or following aspects, or in the alternative to some aspects, the sensing unit can be configured to be mounted on a fluid line, but not in direct contact with a fluid inside the fluid line.

In a seventy-fifth aspect, in addition to one or more of the preceding or following aspects, or in the alternative to some aspects, wherein at least part of the sensing unit can be configured to be wrapped around a fluid line.

In a seventy-sixth aspect, in addition to one or more of the preceding or following aspects, or in the alternative to some aspects, the sensing unit can include a flexible substrate.

In a seventy-seventh aspect, in addition to one or more of the preceding or following aspects, or in the alternative to some aspects, the sensing unit can further include two or more sensing elements, wherein the two or more sensing elements can be disposed on the flexible substrate.

In a seventy-eighth aspect, in addition to one or more of the preceding or following aspects, or in the alternative to some aspects, the two or more sensing elements can be positioned to be at different axial and/or radial positions along a fluid line.

In a seventy-ninth aspect, in addition to one or more of the preceding or following aspects, or in the alternative to some aspects, the bypass valve monitoring system can be a liquid filtration bypass valve monitoring system.

In an eightieth aspect, in addition to one or more of the preceding or following aspects, or in the alternative to some aspects, the bypass valve monitoring system can be a hydraulic fluid filtration bypass valve monitoring system.

In an eighty-first aspect, in addition to one or more of the preceding or following aspects, or in the alternative to some aspects, the bypass valve monitoring system can be a gas filtration bypass valve monitoring system.

In an eighty-second aspect, in addition to one or more of the preceding or following aspects, or in the alternative to some aspects, the bypass valve monitoring system can be an air filtration bypass valve monitoring system.

In an eighty-third aspect, a method of detecting bypass valve opening can be included. The method can include recording signals from a sensing unit, the signals can include a signal reflecting acoustics and/or vibrations and a signal reflecting strain, and identifying patterns associated with the signal reflecting acoustics and/or vibrations reflecting valve chatter and then using correlated values of strain from the signal reflecting strain to determine a bypass valve opening state.

In an eighty-fourth aspect, in addition to one or more of the preceding or following aspects, or in the alternative to some aspects, the method can further include identifying changes in signal patterns of the signal reflecting acoustics and/or vibrations associated with strain value changes.

In an eighty-fifth aspect, in addition to one or more of the preceding or following aspects, or in the alternative to some aspects, the method can further include identifying changes in signal patterns of the signal reflecting acoustics and/or vibrations associated with strain value increases, wherein such changes indicate that a bypass valve has at least partially opened.

In an eighty-sixth aspect, in addition to one or more of the preceding or following aspects, or in the alternative to some aspects, the method can further include determining that the bypass valve can be operating in a bypass mode when the signals from the acoustic or vibration sensor is consistent with valve chatter and the strain value is above a threshold value.

In an eighty-seventh aspect, in addition to one or more of the preceding or following aspects, or in the alternative to some aspects, the method can further include distinguishing between a cold start bypass event and a normal operation bypass event based at least in part on a signal from a temperature sensor.

In an eighty-eighth aspect, in addition to one or more of the preceding or following aspects, or in the alternative to some aspects, the method can further include estimating filter remaining useful life based on detected normal operation bypass events.

In an eighty-ninth aspect, in addition to one or more of the preceding or following aspects, or in the alternative to some aspects, the method can further include estimating filter remaining useful life based on an amount of time that the bypass valve is in an open position during normal operation bypass events.

In a ninetieth aspect, in addition to one or more of the preceding or following aspects, or in the alternative to some aspects, the sensing unit includes a first sensing element to generate the signal reflecting acoustics and/or vibrations and a second sensing element to generate the signal reflecting strain.

In a ninety-first aspect, in addition to one or more of the preceding or following aspects, or in the alternative to some aspects, the method can further include wrapping the sensing unit around a fluid line.

In a ninety-second aspect, in addition to one or more of the preceding or following aspects, or in the alternative to some aspects, the sensing unit includes sensing elements that do not directly contact a fluid within a fluid line.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of a piece of equipment including a bypass valve monitoring system in accordance with various embodiments herein.

FIG. 2 is a schematic view of a hydraulic system for monitoring in accordance with various embodiments herein.

FIG. 3 is a schematic view of components of a bypass valve monitoring system in accordance with various embodiments herein.

FIG. 4 is a view of pressure signal data in accordance with various embodiments herein.

FIG. 5 is a schematic view of a bypass valve monitoring system in accordance with various embodiments herein.

FIG. 6 is a schematic view of a data communication network in accordance with various embodiments herein.

FIG. 7 is a block diagram view of components of a bypass valve monitoring system in accordance with various embodiments herein.

FIG. 8 is schematic view of a sensor connected to a fluid line in accordance with various embodiments herein.

FIG. 9 is a schematic view of a sensor disposed on a fluid line in accordance with various embodiments herein.

FIG. 10 is a schematic view of components of a bypass valve monitoring system in accordance with various embodiments herein.

FIG. 11 is a schematic view of a wrap sensor configuration in accordance with various embodiments herein.

FIG. 12 is a schematic view of a wrap sensor configuration in accordance with various embodiments herein.

FIG. 13 is a flowchart of operations in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As referenced above, bypass valves allow a fluid to bypass a filtration component under certain circumstances (such as bypassing a clogged filter element). While bypass valves can be necessary to ensure sufficient continued fluid flow through a system, they also allow for unfiltered fluid to circulate through a system. Unfiltered fluid may result in contaminants circulating causing excess wear on the system. Thus, operating in a bypass mode has downsides and detecting and/or tracking when the system is operating in a bypass mode is valuable.

Embodiments herein can include bypass valve monitoring system that can be used to detect and/or calculate various aspects of bypass valve operation including, but not limited to, changes in signal patterns of a high-speed pressure signal (or high-sample rate pressure signal) that are associated with filter restriction pressure changes (or filter pressure drop changes), a specific position of the bypass valve (fully open, partially open, fully closed, etc.), a bypass valve opening pressure (or “cracking pressure”), an amount of time that the bypass valve has operated in a bypass state, and the like. Systems herein can also use such information to determine aspects such as remaining filter life, recommended servicing times, bypass valve fatigue, and the like.

Embodiments of bypass valve monitoring systems herein can specifically include a control circuit and a sensing unit. The sensing unit can generate a high-speed pressure signal (or high sample rate pressure signal) and a filter restriction pressure signal (or filter pressure drop signal). The bypass valve monitoring system can be configured to record signals from the sensing unit and identify patterns in the high-speed pressure signal associated with filter restriction pressure levels. The identified patterns can be used to indicate a position of the bypass valve.

In some embodiments, a bypass valve monitoring system herein can include a control circuit and a sensing unit in electronic communication with the control circuit. The sensing unit can generate a signal reflecting acoustics and/or vibrations and a signal reflecting strain. The bypass valve monitoring system can be configured to record signals from the sensing unit and identify patterns associated with the signal reflecting acoustics and/or vibrations reflecting valve chatter and then use correlated values of strain from the signal reflecting strain to determine a bypass valve opening state. In some embodiments, the bypass valve monitoring system can be configured to identify patterns of the signal reflecting acoustics and/or vibrations indicating valve chatter associated with strain changes. In some embodiments, the bypass valve monitoring system can be configured to identify patterns of the signal reflecting acoustics and/or vibrations indicating valve chatter associated with strain increases, wherein such occurrences indicate that a bypass valve has at least partially opened.

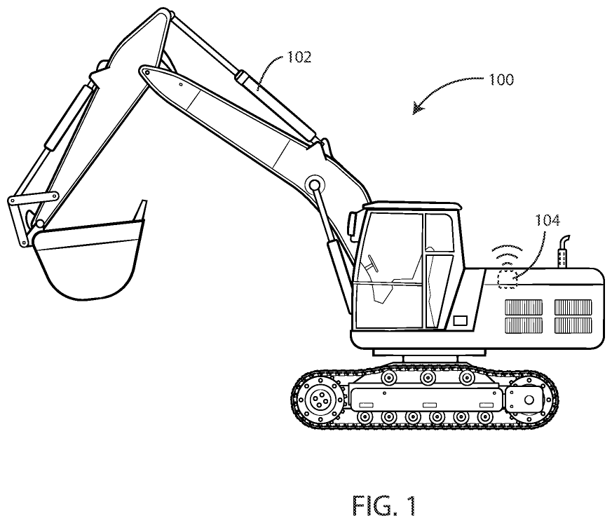

Referring now to FIG. 1, a schematic view is shown of a piece of equipment 100. The equipment 100 includes a hydraulic actuator 102. The equipment 100 can also include a bypass valve monitoring system 104 in accordance with various embodiments herein to monitor a bypass valve for a filtration system that filters hydraulic fluid. It will be appreciated, however, that bypass valve monitoring systems can also be used to monitor bypass valves for filtration systems used to filter other types of fluids including, but not limited to, various liquids (fuel, oil, lubricant, coolant, water, other liquids, and the like) and various gases (air, oxygen, mixed gases, and the like).

The sensing unit can generate a high-speed pressure signal and a signal indicative of filter restriction pressure. When bypass valves open, they generally create pressure waves at various frequencies. As used herein, high speed pressure refers to pressure signals including frequency content sufficiently high in frequency to capture pressure wave frequencies generated by valve opening events, such as at frequencies of greater than 10 Hz. A high-speed pressure signal can also be referred to as a high-sample rate pressure signal. In general, high speed pressure is measured with pressure sensors and/or other sensors such as acoustic sensors including relatively high sample rates. Filter restriction pressure is generally a largely static pressure value and can therefore be measured with pressure sensors having relatively lower sampling rates. Filter restriction pressure can also be referred to as filter pressure drop.

It will be appreciated, however, that in some embodiments both high speed pressure and filter restriction pressure data can be derived from signals from the same pressure sensor depending on the frequency content thereof. It will be appreciated that sensors as described herein can include one or more sensing elements or sensing subcomponents unless the context dictates otherwise.

In various embodiments, the bypass valve monitoring system 104 can be configured to record and/or evaluate such signals from the sensing unit. For example, the bypass valve monitoring system 104 can be configured to identify patterns in the high-speed pressure signal associated with filter restriction pressure levels which indicate a position of the bypass valve. In various embodiments, the bypass valve monitoring system 104 can be configured to identify changes in signal patterns of the high-speed pressure signal associated with filter restriction pressure changes. Such changes can indicate a change in the opening state of the bypass valve (such as changing from fully closed to partially open, partially open to fully open, fully open to partially open, partially open to fully closed, etc.).

In various embodiments, the bypass valve monitoring system 104 can be configured to estimate bypass valve (described further below) opening pressure. In various embodiments, the bypass valve monitoring system 104 can be configured to determine valve opening pressure based on a filter restriction pressure at a time of detected valve opening. In various embodiments, the bypass valve monitoring system 104 can be configured to track changes in valve opening pressure over time. Such changes may reflect fatigue of the bypass valve occurring over time. For example, the bypass valve may wear out over time and as it does the opening pressure or cracking pressure changes.

In various embodiments, the bypass valve monitoring system 104 can be configured to calculate and/or estimate various aspects regarding a filtration system or filter element thereof. For example, in various embodiments, the bypass valve monitoring system 104 can be configured to estimate filter remaining useful life based on detected valve opening events. In various embodiments, the bypass valve monitoring system 104 can be configured to estimate filter remaining useful life based on an amount of time that the bypass valve is in an open position. In various embodiments, the bypass valve monitoring system 104 can be configured to estimate filter remaining useful life based on a percentage of time that the bypass valve is in an open (including partially open) position. In some embodiments, the bypass valve monitoring system 104 can be configured to estimate filter remaining useful life based on the frequency with which filtration system operates in a bypass mode. As merely one example, a standard curve relating estimated remaining useful life of the filter versus the number of times that the system operates in a bypass mode over a set period of time and/or a total amount of time operating in a bypass mode over a set period of time and/or a percentage of time operating in a bypass mode over a set time period can be referenced to convert such measures into an estimated remaining useful life of the filter and/or remaining time until servicing or cleaning is recommended.

Patterns of bypass events over time can also be used to estimate remaining useful life of a filter. While not intending to be bound by theory, with all other factors being equal, bypass valve events will occur more frequently as the level of filter loading increases. As such, by monitoring bypass events over time and noting changes in the frequency thereof the system can estimate filter loading and, therefore, estimate remaining useful life of the filter and/or remaining time until servicing or cleaning is recommended. For example, based on an observed rate of change in bypass event frequencies, the system can estimate how long it will take for the bypass event frequency to achieve a threshold level representing an end of useful life for the filter and/or that servicing or cleaning is currently recommended.

In various embodiments, the bypass valve monitoring system 104 can be configured to distinguish between cold start bypass and filter loading bypass based at least in part on a signal from the temperature sensor (described further below). As such, the bypass valve monitoring system 104 can be configured to estimate filter remaining useful life using any of the techniques described herein while discounting or otherwise not counting cold start bypass events.

In some embodiments, the bypass valve monitoring system 104 is configured to utilize signals from a cold start bypass to train the system to detect a valve bypass event. For example, cold start bypass may be expected when the temperature is below a certain threshold value due to impact on fluid viscosity as explained below. In that scenario, the patterns of the high-speed pressure signal can be recorded and taken as an example pattern or template of bypass mode operation (a positive example pattern). The use of templates in pattern matching to determine the bypass valve position is described further below, but in various embodiments when the same pattern is observed again and the temperature is in the normal operating range then the occurrence of the pattern can be taken as an indication of a filter loading bypass event.

In various embodiments, the bypass valve monitoring system 104 can be configured to evaluate a time domain differential pressure based on signals of two pressure sensors. In various embodiments, the bypass valve monitoring system 104 can be configured to identify patterns in the time domain differential pressure indicating that a bypass valve has at least partially opened. In various embodiments, the bypass valve monitoring system 104 can be configured to identify patterns in the time domain differential pressure associated with pressure changes indicating that a bypass valve is at least partially open. In various embodiments, the bypass valve monitoring system 104 can be configured to identify changes in time domain differential pressure signal patterns occurring as differential pressure increases, wherein such changes indicate that a bypass valve has at least partially opened.

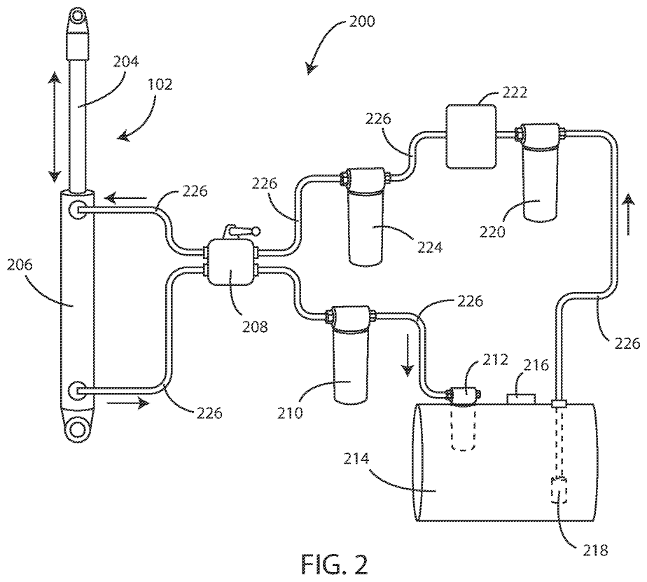

Referring now to FIG. 2, a schematic view of a hydraulic system 200 is shown in accordance with various embodiments herein. It will be appreciated that in many embodiments of hydraulic systems not all of the various filters or other components depicted in FIG. 2 may actually be present. Regardless, the illustrated system 200 includes a hydraulic actuator 102. The hydraulic actuator 102 includes a cylinder barrel 206 and a piston rod 204. Hydraulic fluid moves through the system 200 as controlled with a control unit 208 and passes through a hydraulic fluid line 226. An amount of hydraulic fluid is stored within a reservoir tank 214 and passes through a strainer 218 before traveling through the hydraulic fluid line 226 and passing to a low (or suction) pressure filter 220 before going to a hydraulic fluid pump 222. The hydraulic fluid is then pumped to a medium or high-pressure filter 224 and then passes through the control unit 208 and then onto the hydraulic cylinder 202. On the return path, the hydraulic fluid then passes through the control unit 208 and then passes through a return line filter 210 before passing through an in-tank return filter 212 and entering the reservoir tank 214. The reservoir tank 214 can include a breather 216. In some embodiments, the hydraulic system 200 can also include a kidney loop system (not shown in this view). A kidney loop system can include a pump and a filter and can operate to pump fluid from the reservoir tank 214 through the filter and back to the reservoir tank 214 so that the kidney loop functions to clean the fluid within the reservoir tank 214.

Sensors for bypass valve monitoring systems herein can be mounted at various points along the hydraulic system 200. In some embodiments, sensors can be mounted along the hydraulic fluid line 226. In some embodiments, one or more sensors can be mounted within or on a hydraulic system at an area under vacuum pressure. In some embodiments, one or more sensors can be mounted within or on a hydraulic system at an area under a substantially ambient pressure. In various embodiments, some sensors can be mounted within or on a hydraulic system downstream from a filter and upstream from a filter. It will be appreciated that sensors for systems herein (or components of the same) can be mounted upstream or downstream of any of the fluid filters described herein or at other locations. In various embodiments, at least some of the sensors of the systems herein can also be mounted on or in fluid flow lines.

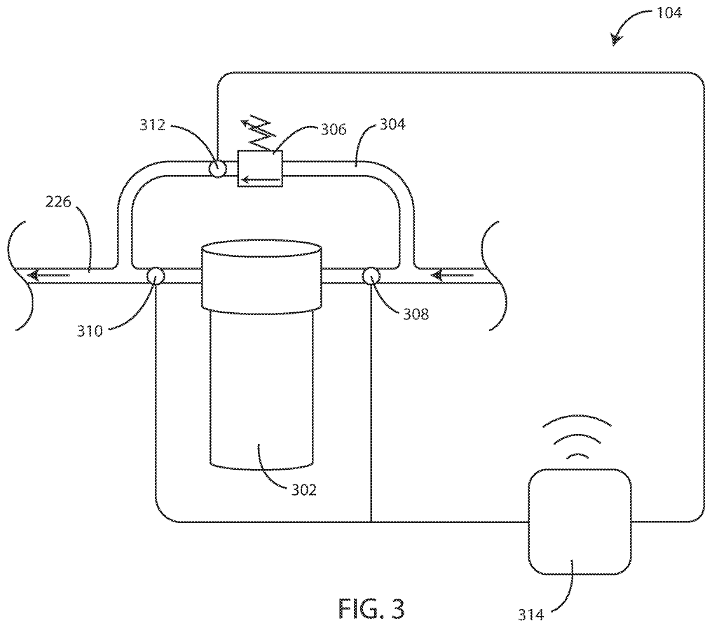

Referring now to FIG. 3, a schematic view of components of a bypass valve monitoring system 104 is shown in accordance with various embodiments herein. The fluid system includes a fluid line 226 and a filter unit 302 arranged to filter a fluid flowing through the fluid line 226. The fluid system also includes a bypass channel 304 with a bypass valve 306 controlling fluid flow through the bypass channel 304.

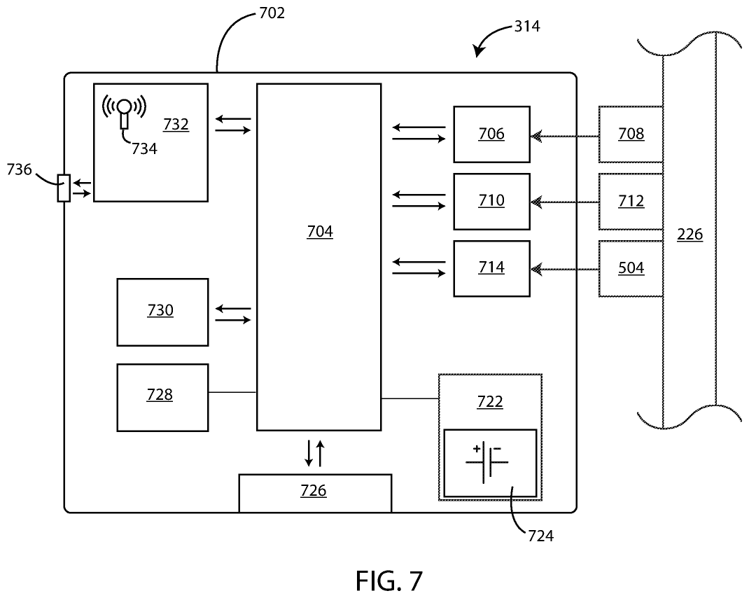

The bypass valve monitoring system 104 can include control unit 314. The control unit 314 can include various components such as a control circuit and other components as described below with respect to FIG. 7. The bypass valve monitoring system 104 also includes a first sensor unit 312, which can include one or more sensing elements. In various embodiments, the first sensor unit 312 is a high-speed sensor. For example, in some embodiments, the first sensor unit 312 has a sampling rate of at least 8,000 Hz. In various embodiments, the first sensor unit 312 is, specifically, a high-speed pressure sensor. However, in some embodiments, the first sensor unit 312 can include a microphone or a similar sensor.

The bypass valve monitoring system 104 can also include a second sensor unit which can include one or more sensing elements. The second sensor unit can measure a filter restriction pressure. The second sensor unit in this embodiment includes an upstream sensor 308 (upstream of the filter), which can include one or more sensing elements, and a downstream sensor 310 (downstream of the filter), which can include one or more sensing elements, that can be used to measure a differential pressure indicative of filter restriction pressure. However, in some embodiments only a single pressure sensor is used to measure a filter restriction pressure such as where one side of the filter is at a pressure that is maintained at about ambient pressure. In some embodiments 310 and 308 can be a differential pressure sensor, integrated or not. In some embodiments, the functionality of first sensor unit 312 (such as a high-speed pressure sensor) can be integrated with sensor 310 or sensor 308 in a single sensor.

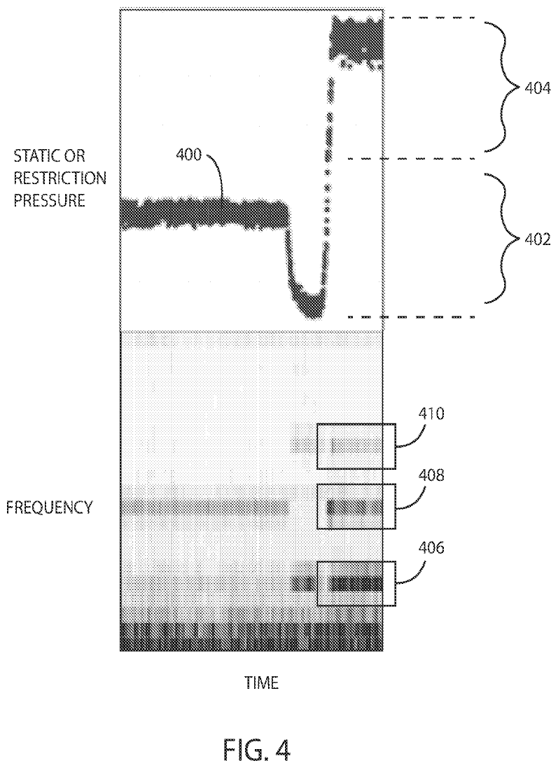

Referring now to FIG. 4, a view of pressure signal data is shown in accordance with various embodiments herein. As can be seen, the filter restriction pressure 400 (or static pressure) changes over time. In this example, the filter restriction pressure 400 over time includes a span of time where the valve is closed (a valve closure zone 402). The filter restriction pressure 400 also includes a span of time where the valve is at least partially open (a valve opening zone 404). The valve opening zone 404 corresponds with a relatively higher filter restriction pressure 400.

FIG. 4 also shows frequencies from the high-speed pressure signal. As can be seen, the frequency pattern changes corresponding with the valve opening. The pattern of frequencies associated with the valve opening, in this example, is a multi-band pattern including a concentrated first frequency band 406, a second frequency band 408, and a third frequency band 410. By observing how the pattern of frequencies change associated with the observed change in the filter restriction pressure, the system can determine the position of the bypass valve, such as that the bypass valve has begun to open.

In various embodiments, the bypass valve monitoring system can be configured to identify changes in signal patterns of the high-speed pressure signal associated with filter restriction pressure changes. In various embodiments, the bypass valve monitoring system can be configured to identify changes in signal patterns of the high-speed pressure signal associated with filter restriction pressure increases, wherein such changes indicate that a bypass valve 306 has at least partially opened.

In various embodiments, the bypass valve monitoring system can be configured to identify specific signal patterns of the high-speed pressure signal. Various techniques can be used to identify specific patterns in the high-speed pressure signal. For example, in some embodiments the system can execute a pattern matching algorithm to match the observed signals from the high-speed pressure signal against a set of template patterns. For example, the pattern or signal templates can reflect different valve opening states (fully open, partially open, fully closed, etc.). Pattern matching can be performed by the system using techniques as described below. When a match is found between a pattern or signal template and current sensor data, the system can determine that the state associated with the pattern or signal template reflects the current state of the bypass valve.

By observing the filter restriction pressure occurring with the onset of a pattern indicating that the valve has begun opening, the bypass valve monitoring system can be configured to determine valve opening pressure (or valve “cracking” pressure). Thus, in various embodiments, the bypass valve monitoring system 104 can be configured to determine valve opening pressure based on a filter restriction pressure at a time of detected valve opening. In various embodiments, the bypass valve monitoring system 104 can be configured to track changes in valve opening pressure over time.

Once the valve opening pressure is determined, it can be used by the system in various ways. For example, in some embodiments, the bypass valve monitoring system 104 can be configured to determine that the bypass valve 306 is operating in a bypass mode when the filter restriction pressure can be above the determined valve opening pressure.

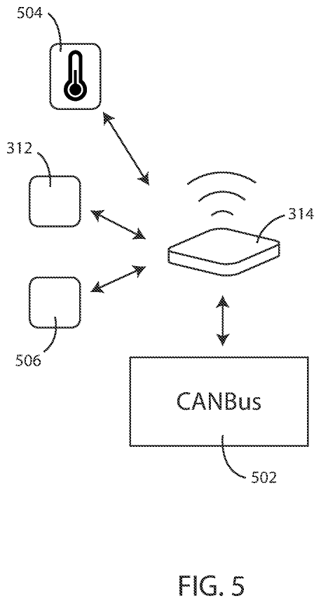

Referring now to FIG. 5, a schematic view of a bypass valve monitoring system is shown in accordance with various embodiments herein. The bypass valve monitoring system includes control unit 314. The bypass valve monitoring system includes a first sensor unit 312 and a second sensor unit 506 (which can include an upstream sensor and a downstream sensor). The bypass valve monitoring system also includes a CANBus interface 502. Communication between system components and/or external components can be via wired or wireless components. Communication can be unidirectional or bidirectional. In some embodiments, a BLUETOOTH protocol can be used for wireless communications, but other communication protocols are also contemplated herein.

The bypass valve monitoring system 104 can also include a temperature sensor 504. Temperature can impact the viscosity of fluids and therefore can impact measured filter restriction pressures. For example, when first started in a cold environment, the hydraulic fluid in a hydraulic system will be cold and exhibit a relatively higher viscosity that will contribute to higher filter restriction which might be sufficient to cause the bypass valve to open at least partially. In various embodiments, the bypass valve monitoring system 104 can be configured to distinguish between cold start bypass and filter loading bypass based at least in part on a signal from the temperature sensor 504. For example, if the system detects a frequency pattern consistent with bypass valve opening and the temperature is below a threshold value, the system can determine that bypass event is a cold start bypass. In various embodiments, the control circuit can be configured to utilize signals from a cold start bypass to train the system to detect a valve bypass event.

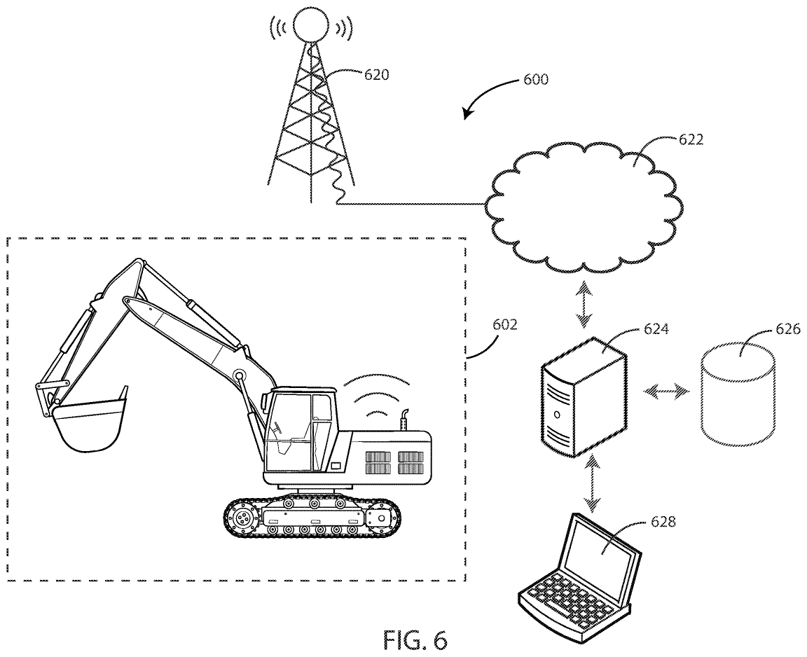

Referring now to FIG. 6, a schematic view of a data communication network 600 is shown in accordance with various embodiments herein. The data communication network 600 includes a local zone 602. The filtration system including a bypass valve and at least some components of the monitoring system can be within the local zone 602. The data communication network 600 also includes a data communication tower 620 or antenna, such as a cellular communications tower. Data can be exchanged wirelessly between the monitoring system and various other components or systems such as may be facilitated by the data communication tower 620. The data communication network 600 can also include various resources available in or accessible through the cloud 622. For example, the data communication network 600 can includes a remote server 624 (real or virtual) accessible through the cloud 622. The data communication network 600 can also include a remote database 626 accessible through the cloud 622. The data communication network 600 can also include a remote computer 628 or terminal for a remote user to access the system. It will be appreciated that processing operations described herein can be performed at the level of the local zone 602, the cloud 622, remote servers 624, or the like, or distributed across one or more of the same.

Referring now to FIG. 7, a block diagram view of components of a bypass valve monitoring system is shown in accordance with various embodiments herein. It will be appreciated that a greater or lesser number of components can be included with various embodiments and that this schematic diagram is merely illustrative. The vehicle or equipment (not shown in this view) for which a bypass valve is used includes a fluid line 226. The monitoring system can include a control unit 314 including a housing 702 and a control circuit 704 disposed therein. The control circuit 704 can include various electronic components including, but not limited to, a microprocessor, a microcontroller, a FPGA (field programmable gate array) chip, an application specific integrated circuit (ASIC), one or more digital signal processing chips, or the like.

In various embodiments, the monitoring system can include a high-speed sensor unit 708 and a high-speed sensor unit channel interface 706. In various embodiments, the monitoring system can include a filter restriction pressure sensor unit 712 and a filter restriction pressure sensor channel interface 710. In various embodiments, the monitoring system can include a temperature sensor 504 and a temperature sensor channel interface 714. In some embodiments, the system can include one or more strain sensors or strain sensing elements. The sensors can be configured and mounted on or in a fluid line to detect fluid conditions within a fluid line 226. The fluid line 226 can, in some cases, form part of a device such as a pump, a valve, a filter housing, or the like. The fluid line 226 can include, in some embodiments, a hydraulic fluid conduit, a lubricating oil conduit, a brake fluid conduit, a refrigerant fluid conduit, a fuel supply conduit, a water flow conduit, an air flow conduit, or another type of gas flow conduit, amongst others.

The channel interfaces can include various components such as amplifiers, analog-to-digital converters (ADCs), digital-to-analog converters (DACs), digital signal processors (DSPs), filters (high-pass, low-pass, band-pass) and the like. In some cases, the channel interfaces may not exist as discrete components but, rather, can be integrated into the control circuit 704.

The processing power of the control circuit 704 and components thereof can be sufficient to perform various operations including various operations on signals/data from sensors (such as sensors 708, 712, and 504) including, but not limited to averaging, time-averaging, statistical analysis, normalizing, aggregating, sorting, deleting, traversing, transforming, condensing (such as eliminating selected data and/or converting the data to a less granular form), compressing (such as using a compression algorithm), merging, inserting, time-stamping, filtering, discarding outliers, calculating trends and trendlines (linear, logarithmic, polynomial, power, exponential, moving average, etc.), normalizing data/signals, and the like. Fourier analysis can decompose a physical signal into a number of discrete frequencies, or a spectrum of frequencies over a continuous range. In various embodiments herein, operations on signals/data can include Fast Fourier Transformations (FFT) to convert data/signals from a time domain to a frequency domain. Other operations on signals/data here can include spectral estimation, frequency domain analysis, calculation of root mean square acceleration value (G_{RMS}), calculation of acceleration spectral density, power spectral densities, Fourier series, Z transforms, resonant frequency determination, harmonic frequency determination, and the like. It will be appreciated that while various of the operations described herein (such as Fast Fourier transforms) can be performed by general-purpose microprocessors, they can also be performed more efficiently by digital signal processors (DSPs) which can, in some embodiments, be integrated with the control circuit 704 or may exist as separate, discrete components.

Normalizing operations performed by the control circuit 704 can include, but are not limited to, adjusting one or more values based on another value or set of values. In some embodiments herein, normalizing operations can specifically include normalizing the pressure sensor signals based on a pump operating speed or other equipment operating speed. As an example, a pump may have an operating frequency (speed). Characteristically, a pressure sensor of the system is likely to pick up a significant amount of vibration at a frequency that is at or near the operating frequency of the pump. As such, normalizing data/signals from a vibration sensor can include removing, canceling, attenuating, or otherwise accounting for the contribution to the frequency spectrum of pressure oscillations that is provided due to the operating frequency of the pump or other piece of equipment. In some cases, this can include dropping or otherwise not using pressure signals at or near the operating speed of the pump or other equipment. In some cases, this can include dropping or otherwise not using pressure signals in a band encompassing the operating speed of the pump or other equipment. In some cases, this can include dropping or otherwise not using pressure signals in a series of bands encompassing the operating speed of the pump or other equipment and at other frequencies representing harmonic frequencies of the operating speed of the pump or other equipment.

In various embodiments, the monitoring system can include a power supply circuit 722. In some embodiments, the power supply circuit 722 can include various components including, but not limited to, a battery 724, a capacitor, a power-receiver such as a wireless power receiver, a transformer, a rectifier, and the like.

In various embodiments the monitoring system can include an output device 726. The output device 726 can include various components for visual and/or audio output including, but not limited to, lights (such as LED lights), a display screen, a speaker, and the like. In some embodiments, the output device can be used to provide notifications or alerts to a system user such as current system status, an indication of a problem, a required user intervention, a proper time to perform a maintenance action, or the like.

In various embodiments the monitoring system can include memory 728 and/or a memory controller. The memory can include various types of memory components including dynamic RAM (D-RAM), read only memory (ROM), static RAM (S-RAM), disk storage, flash memory. EEPROM, battery-backed RAM such as S-RAM or D-RAM and any other type of digital data storage component. In some embodiments, the electronic circuit or electronic component includes volatile memory. In some embodiments, the electronic circuit or electronic component includes non-volatile memory. In some embodiments, the electronic circuit or electronic component can include transistors interconnected to provide positive feedback operating as latches or flip flops, providing for circuits that have two or more metastable states, and remain in one of these states until changed by an external input. Data storage can be based on such flip-flop containing circuits. Data storage can also be based on the storage of charge in a capacitor or on other principles. In some embodiments, the non-volatile memory 728 can be integrated with the control circuit 704.

In various embodiments the monitoring system can include a clock circuit 730. In some embodiments, the clock circuit 730 can be integrated with the control circuit 704. While not shown in FIG. 7, it will be appreciated that various embodiments herein can include a data/communication bus to provide for the transportation of data between components such as an I²C, a serial peripheral interface (SPI), a universal asynchronous receiver/transmitter (UART), or the like. In some embodiments, an analog signal interface can be included. In some embodiments, a digital signal interface can be included.

In various embodiment the monitoring system can include a communications circuit 732. In various embodiments, the communications circuit can include components such as an antenna 734, amplifiers, filters, digital to analog and/or analog to digital converters, and the like. In some embodiments, the monitoring system can also include wired input/out interface 736 for wired communication with other systems/components including, but not limited to a vehicle ECU, a CANBUS network (controller area network), or the like.

Pressure sensors herein can be of various types. Pressure sensors can include, but are not limited to, strain sensors, strain gauge type pressure sensors, capacitive type pressure sensors, piezoelectric type pressure sensors, and the like. In some embodiments, pressure sensors herein can be MEMS-based pressure sensors.

In various embodiments, the high-speed sensor unit 708 can include a high-speed (e.g., high sample rate) pressure sensor. In various embodiments the high-speed pressure sensor can sample at rates of 1,000, 1,500, 2,000, 2,500, 3,000, 5,000, 8,000, 10,000, 15,000, 20,000 Hz or higher, or at a rate falling within a range between any of the foregoing. In various embodiments the high-speed pressure sensor can have a response time of less than 10, 5, 2.5, 1, 0.5, 0.25, 0.1, 0.05 or 0.01 milliseconds, or a response time falling within a range between any of the foregoing.

In some embodiments, the high-speed pressure sensor can be an acoustical transducer, such as a microphone or the like. Microphones can include, but are not limited to, condenser (including diaphragm condenser) microphones, ribbon microphones, dynamic (including induction coil) microphones, and the like.

Temperature sensors herein can be of various types. In some embodiments, the temperature sensor 504 can be a thermistor, a resistance temperature device (RTD), a thermocouple, a semiconductor temperature sensor, or the like.

It will be appreciated that sensors herein can include those sensors that are inserted into a fluid line for direct contact with a fluid within the fluid line (e.g., a direct contact sensor) as well as those that can be mounted on a fluid line but do not require insertion into the fluid line or direct contact with the fluid (e.g., a non-contact, indirect, or non-invasive sensor). While not intending to be bound by theory, sensors mounted on a fluid line that do not require insertion into the fluid line can be more easily installed, particularly in a retrofit scenario.

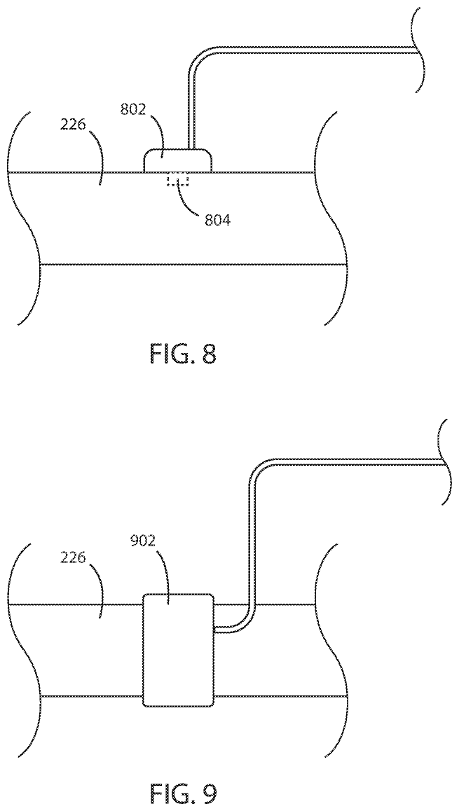

Referring now to FIG. 8, a schematic view of a sensor 802 as connected to a fluid line 226 is shown in accordance with various embodiments herein. As can be seen, a portion 804 of the sensor 802 passes into the fluid line 226. In contrast, referring now to FIG. 9, a schematic view of a sensor 902 disposed on a fluid line 226 is shown in accordance with various embodiments herein. In this example, the sensor 902 is disposed only on the outside of the fluid line 226. The sensor 902 (and/or various sensing elements thereof) can be applied directly to the fluid line 226 (an thus be applied separately from other sensors or system components) and/or take the form of a pad, sleeve, wrap, or the like. Wraps can take form of ring-like configurations where the end of the wrap is at the same axial (or longitudinal) position along a fluid line as the start of the wrap. Wraps can also take the form of helical configurations where the end of the wrap is at a different axial position along a fluid line as the start of the wrap.

It will be appreciated that in some cases indirect sensors gather data from which pressure can be inferred or estimated. In some cases, systems herein can execute operations to infer or estimate pressure from indirect sensor data. In other cases, however, systems herein can operate on the data from indirect sensors without needing to infer or otherwise convert the same to pressure data. For example, detection of bypass valve opening/valve state can be performed using data from a sensor (such as a strain gauge, strain sensor, or strain sensing element) that is correlated to pressure, but is not a direct pressure measurement. Strain sensors herein can include, but are not limited to, piezoelectric, triboelectric, resistive, semiconductor, nanoparticle, fiber optic, other optical, MEMS based, MOEMS based, and quartz crystal based strain sensors/sensing elements and the like.

In one approach, an indirect sensor (such as might constitute a strain gauge on the exterior of a fluid line) value can be gathered for both upstream and downstream positions and then a change over a baseline value can be determined (delta value), such as a change in strain from the baseline value (what the fluid line rests at). Then, differential strain can be calculated by taking the upstream delta value (such as upstream delta strain) and subtracting the downstream delta value (such as downstream delta strain).

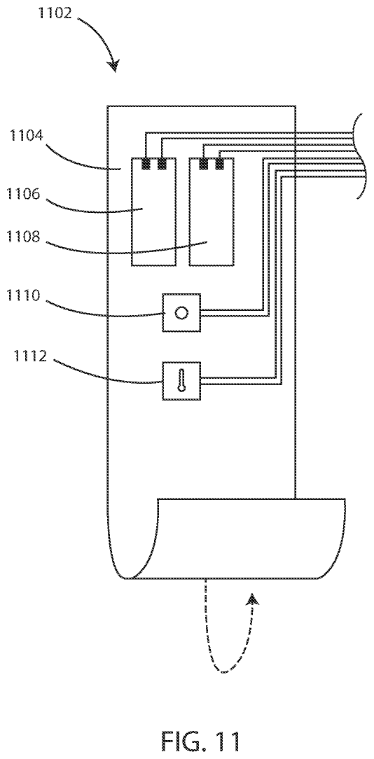

Bypass state can be determined in various ways using the indirect sensor (such as strain gauge) data and data from other sensors described herein such an acoustic or vibration sensor to detect valve chatter (described with respect to FIG. 11 herein) and/or data from a temperature sensor (described with respect to FIG. 11 herein). It will be appreciated that in some embodiments, strain sensor(s) and an acoustic or vibration sensor can be two different types of sensors. However, in some embodiments, strain sensor(s) can be used to both detect strain as well as detect acoustic signals and/or vibration signals.

In one approach, valve opening can be detected by detecting a pattern of acoustic or vibration signals/data indicating valve chatter (such as by using various pattern detection and/or pattern matching techniques such as those described herein) and correlating the same to a particular strain gauge level (where the strain gauge level reflects filter restriction pressure). In some cases, the bypass valve can be deemed open when the level of strain or differential strain is above a threshold value (related to the bypass valve rating) or within a particular range of values consistent with the bypass valve being open. Temperature data can then be used to distinguish between the bypass valve opening due to a cold start-up (such as if the temperature is below a threshold value) or normal operation.

In another approach, valve opening can be detected by detecting a pattern of acoustic or vibration signals/data indicating valve chatter is occurring in combination with a strain value or differential strain value described above increasing. Similarly, valve closing can be detected by detecting a pattern of acoustic or vibration signals/data indicating valve chatter is occurring in combination with a strain value or differential strain value described above decreasing.

As with various other embodiments herein, in some cases a single sensor can be used with respect to detecting bypass around a particular filtration component and in other cases two or more sensors can be used. For example, in the context of a high-pressure filter, two sensors can be used including an upstream sensor and a downstream sensor. However, if the downstream side of filter connects to an area with ambient pressure, such as may be the case with a return line filter, an in-tank return filter, and a suction filter, then a single sensor positioned upstream can be used. Table 1 below illustrates some scenarios where different numbers of sensors can be used depending on the filter location.

TABLE 1

| Filter Location | Upstream Sensor(s) | Downstream Sensor(s) |
|---|---|---|
| Suction | Not Necessary* | 3-Sensor/Data Channel |
| | | Combination |
| Pressure | 3-Sensor/Data | 1-Sensor |
| Configuration A | Channel | |
| | Combination | |
| Pressure | 1-Sensor | 3-Sensor/Data Channel |
| Configuration B | | Combination |
| Return | 3-Sensor/Data | Not Necessary* |
| | Channel | |
| | Combination | |

*If reservoirs are at atmospheric pressure, then not necessary.
** Three sensor/channel combinations can include sensors/sensing elements as described herein, such as those with pressure/strain sensors/sensing elements, acoustic or vibration sensors/sensing elements (chatter), and temperature sensors configured to be applied to a fluid line in combination as a wrap (or other semi-integrated form) sensor or configured to be applied separately and/or with other mechanisms. It will be appreciated that in some embodiments, less than 3 discrete sensors or sensing elements can be used to detect/measure three different data channels (such as measure pressure, identify valve chatter, and measure temperature). For example, a single sensor may be able to measure pressure and identify valve chatter. As such, a 3-Sensor/Channel combination herein can refer to measurement with three distinct sensors or measurement with, for example, two distinct sensors such as when pressure and valve chatter are measured/identified with a single sensor. Furthermore, in some cases a particular sensor (such as a pressure/strain sensor) can have multiple sensing elements, such as multiple strain sensing elements.

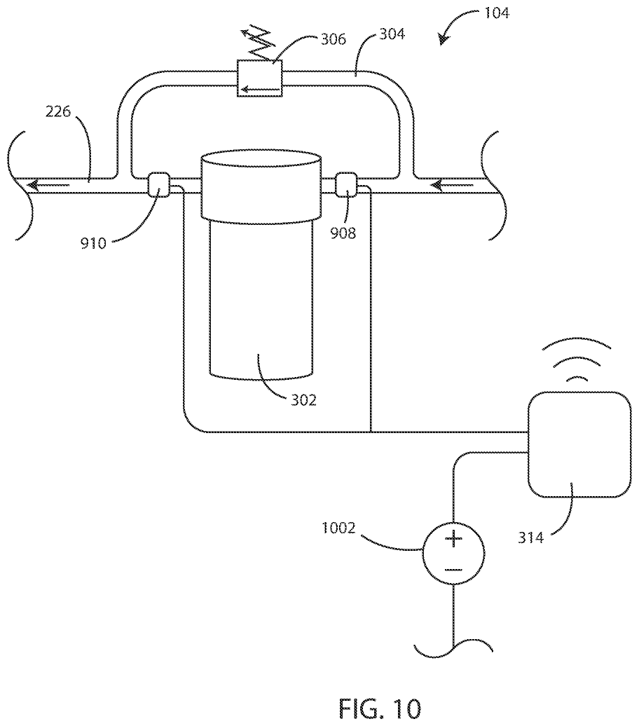

Referring now to FIG. 10, a schematic view is shown of components of a bypass valve monitoring system in accordance with various embodiments herein. The system as shown in FIG. 10 is generally similar to that of FIG. 3. As such, the bypass valve monitoring system 104 is shown along with a fluid system that includes a fluid line 226 and a filter unit 302 arranged to filter a fluid flowing through the fluid line 226. The fluid system also includes a bypass channel 304 with a bypass valve 306 controlling fluid flow through the bypass channel 304. The bypass valve monitoring system 104 includes control unit 314, which can include various components such as a control circuit and other components as described elsewhere herein. In this embodiment, a power source 1002 is also shown, which could be from a vehicle or piece of equipment that the bypass valve monitoring system is mounted on or in.

In this embodiment, the bypass valve monitoring system 104 includes an upstream sensor 908 (upstream of the filter) and a downstream sensor 910 (downstream of the filter) that can be used to gather signals that can be used to identify a bypass event. In some embodiments, the upstream sensor 908 and/or the downstream sensor 910 can be as indicated in Table 1 above. Further, as indicated in Table 1, depending on the filter location, the upstream sensor 908 (such as in the case of a suction filter) or the downstream sensor 910 (such as in the case of a return filter) can be, but is not required to be, omitted.

Referring now to FIG. 11, a schematic view of a wrap sensor configuration is shown in accordance with various embodiments herein. In this embodiment, the wrap sensor 1102 is configured to be wrapped around a fluid line. The wrap sensor 1102 can include a flexible substrate 1104 and various sensing elements disposed there on. The flexible substrate 1104 can be formed with polymers, metals, composites, or the like. The flexible substrate 1104 can be sufficiently long to accommodate being wrapped around fluid lines of various sizes. In some embodiments, the flexible substrate 1104 can include an adhesive disposed on a surface thereof (such as the inner surface) to fasten the wrap sensor 1102 to a fluid line. In some embodiments, the wrap sensor 1102 can be fastened using mechanical mechanisms such as a buckle, strap, etc.

In some embodiments, the wrap sensor 1102 can include a first pressure sensing element 1106 and a second pressure sensing element 1108. In some cases, each pressure sensing element can independently create a signal that can be received by other components of the system and processed as described herein. However, in other embodiments, the wrap sensor 1102 may only include a single pressure sensing element or in some cases more than two pressure sensing elements. The pressure sensing elements can be of any of the types previously described for pressure sensors.

Various other types of sensors can be included with the wrap sensor 1102. In some embodiments, the wrap sensor 1102 can also include an acoustic or vibration sensor 1110 (such as a microphone or accelerometer). Data/signals from the acoustic or vibration sensor 1110 can be useful to detect valve chatter, which can be indicative of a bypass valve opening or closing. However, in some embodiments, sensing of valve chatter can be performed with the pressure sensing element(s), such as with a strain sensing element and, as such, the acoustic or vibration sensor 1110 can be omitted.

In some embodiments, the wrap sensor 1102 can also include a temperature sensing element 1112 (such as a thermistor, resistance temperature detector (RTD), thermocouple, semiconductor or integrated circuit (IC) temperature sensors, or the like). Data/signals from the temperature sensing element 1112 can be useful to compensate for a temperature effect on a pressure sensing element such as a strain gauge based sensor. Additionally, fluid temperature can impact bypass valve opening and closing behaviors and, as such, the system can evaluate temperature in combination with valve opening and closing so as to distinguish between cold start-up bypass events and normal operation bypass events.

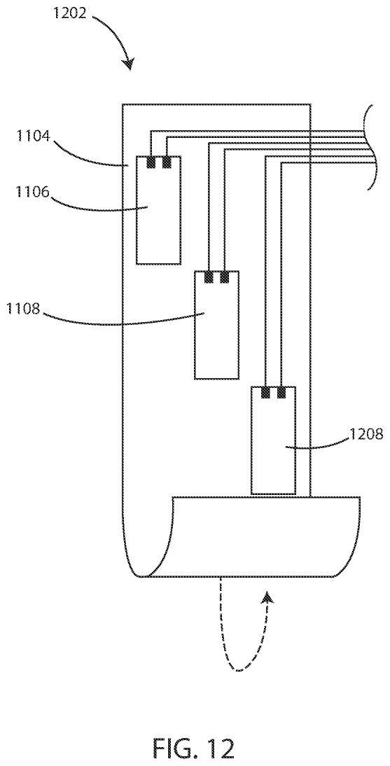

In some embodiments, sensing elements can be in different positions (e.g., different radial and/or axial positions with respect to the fluid line) such that the data they capture is slightly different. For example, it is possible that movement of a fluid line reflecting pressure may be more substantial, more accurate, or have a better signal to noise ratio on one side of a fluid line versus another. By including sensing elements at different positions on a wrap or sleeve, the sensing elements can produce signals reflecting different parts of the fluid line. The system can then use all data or select only data from certain sensing elements (such as those that are most accurate or most responsive to fluid pressure and/or fluid pressure changes). Referring now to FIG. 12, a schematic view of another embodiment of a wrap sensor configuration is shown in accordance with various embodiments herein. In this embodiment, the wrap sensor 1202 includes a flexible substrate 1104, a first pressure sensing element 1106, a second pressure sensing element 1108, and a third pressure sensing element 1208. The pressure sensing elements are in different physical positions. In specific, with respect to a fluid line, the pressure sensing elements would be in different radial and axial positions after the wrap sensor 1102 is installed on a fluid line.

### Methods

Many different methods are contemplated herein, including, but not limited to, methods of making systems herein, methods of using systems herein, methods of monitoring bypass valves and/or filtration systems, methods of tracking bypass valves and/or filtration systems, and the like. Aspects of system/device operation described at various points herein can be performed as operations of one or more methods in accordance with various embodiments herein.

Further, in various embodiments, operations described herein and method steps can be performed as part of a computer-implemented method executed by one or more processors of one or more computing devices. In various embodiments, operations described herein and method steps can be implemented instructions stored on a non-transitory, computer-readable medium that, when executed by one or more processors, cause a system to execute the operations and/or steps.

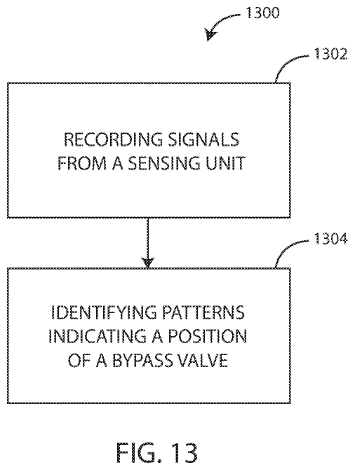

Referring now to FIG. 13, a flowchart of operations is shown in accordance with various embodiments herein. In specific. FIG. 13 shows a method of detecting bypass valve opening 1300. The method of detecting bypass valve opening 1300 can include an operation of recording signals from one or more sensing units 1302. The method of detecting bypass valve opening 1300 can also include an operation of identifying patterns in a high-speed pressure signal indicating a position of the bypass valve 1304. In some embodiments, the method can include an operation of identifying patterns in a high-speed pressure signal that are associated with filter restriction pressure levels indicating a position of the bypass valve.

In some embodiments, the method can further include identifying changes in signal patterns of the high-speed pressure signal associated with filter restriction pressure changes. In some embodiments, the method can further include identifying changes in signal patterns of the high-speed pressure signal associated with filter restriction pressure increases, wherein such changes indicate that a bypass valve has at least partially opened.

In some embodiments, the method can further include determining valve opening pressure. In some embodiments, the method can further include tracking changes in valve opening pressure over time. In some embodiments, the method can further include determining valve opening pressure based on a filter restriction pressure at a time of detected valve opening. In some embodiments, the method can further include determining that the bypass valve is operating in a bypass mode when the filter restriction pressure is above the determined valve opening pressure.

In some embodiments, the method can further include estimating filter remaining useful life based on detected valve opening events. In some embodiments, the method can further include estimating filter remaining useful life based on an amount of time that the bypass valve is in an open position. In some embodiments, the system can distinguish between cold start bypass events and normal operation bypass events as described elsewhere herein and not count or otherwise consider cold start bypass events when calculating filter remaining useful life. For example, the system can distinguish between cold start bypass events and normal operation bypass events only count normal operation bypass events and/or amounts of time spent in a normal operation bypass mode in calculating filter remaining useful life.

In some embodiments, the method can further include distinguishing between cold start bypass and filter loading bypass based at least in part on a signal from a temperature sensor. In some embodiments, the method can further include utilizing signals from a cold start bypass to train the system to detect a valve bypass event.

In an embodiment, a method of detecting bypass valve opening is included, the method including recording signals from a sensing unit, where the signals can include a signal reflecting acoustics and/or vibrations and a signal reflecting strain. The method can further include identifying patterns associated with the signal reflecting acoustics and/or vibrations reflecting valve chatter and then using correlated values of strain from the signal reflecting strain to determine a bypass valve opening state.

In an embodiment, the method can further include identifying changes in signal patterns of the signal reflecting acoustics and/or vibrations associated with strain value changes.

In an embodiment, the method can further include identifying changes in signal patterns of the signal reflecting acoustics and/or vibrations associated with strain value increases, wherein such changes indicate that a bypass valve has at least partially opened.

In an embodiment, the method can further include determining that the bypass valve is operating in a bypass mode when the signals from the acoustic or vibration sensor are consistent with valve chatter and the strain value is above a threshold value.

In an embodiment, the method can further include distinguishing between a cold start bypass event and a normal operation bypass event based at least in part on a signal from a temperature sensor.

In an embodiment, the method can further include estimating filter remaining useful life based on detected normal operation bypass events.

In an embodiment, the method can further include estimating filter remaining useful life based on an amount of time that the bypass valve is in an open position during normal operation bypass events.

In an embodiment of the method, the sensing unit includes a first sensing element to generate the signal reflecting acoustics and/or vibrations and a second sensing element to generate the signal reflecting strain.

In an embodiment, the method can further include wrapping the sensing unit around a fluid line. In an embodiment of the method, the sensing unit includes sensing elements that do not directly contact a fluid within a fluid line.

### Pattern/Template Generation and Pattern Matching

It will be appreciated that in various embodiments herein, the system can be used to detect a pattern or patterns in signals (such as a high-speed pressure signal) indicative of the state of a bypass valve and or patterns in signals (such as acoustic or vibration signals) indicative of valve chatter. Such patterns can be detected in various ways. Some techniques are described elsewhere herein, but some further examples will now be described.

In various embodiments, the system can be configured to detect bypass valve events or states. In some embodiments, bypass valve events or states can be identified based on identifying or matching characteristic patterns in the data from a pressure sensor, a microphone, and/or other sensors. For example, a “positive” pattern for sensor data associated with a particular bypass valve event or state can be stored by the system and current sensor data can be periodically matched against such a pattern. If a match exceeding a threshold value is found, then an operational event or state can be deemed to have taken place. As another example, a “negative” pattern for sensor data associated with a particular operational event or state can be stored by the system and current data can be periodically matched against such a pattern. Similarly, positive and/or negative patterns can be used to identify valve chatter.

In some embodiments, one or more sensors (such as strain sensors, pressure sensors, microphones, or the like) can be operatively connected to a controller (such as the control circuit 704 described in FIG. 7) or another processing resource (such as a processor of another device or a processing resource in the cloud). The control circuit 704 or other processing resource can be adapted to receive data representative of a state of a bypass valve from one or more of the sensors and/or determine statistics of the system over a monitoring time period based upon the data received from the sensor(s). As used herein, the term “data” can include a single datum or a plurality of data values or statistics. The term “statistics” can include any appropriate mathematical calculation or metric relative to data interpretation, e.g., probability, confidence interval, distribution, range, or the like. Further, as used herein, the term “monitoring time period” means a period of time over which signal data is measured and statistics are determined. The monitoring time period can be any suitable length of time, e.g., 1 second, 10 seconds, 30 seconds, 1 minute, 10 minutes, 30 minutes, 1 hour, 1 day, 1 week, 1 month, etc., or a range of time between any of the foregoing time periods.

Any suitable technique or techniques can be utilized to determine statistics for the various data from the sensors, e.g., direct statistical analyses of time series data from the sensors, differential statistics, comparisons to baseline or statistical models of similar data, etc. Such techniques can be general or system-specific and represent long-term or short-term operational behavior. These techniques could include standard pattern classification methods such as Gaussian mixture models, clustering as well as Bayesian approaches, machine learning approaches such as neural network models and deep learning, and the like, and/or combinations of at least two techniques.

Further, in some embodiments, the controller or control circuit 704 can be adapted to compare data, data features, and/or statistics against various other patterns, which could be predetermined or starting patterns (baseline patterns) based on the type or model of the filtration system, one or more predetermined patterns that serve as patterns indicative of an occurrence of an event or state of the bypass valve (positive example patterns), one or more predetermined patterns that service as patterns indicative of the absence of an operational event or state (negative example patterns), or the like. As merely one scenario, if a pattern is detected for a bypass valve that exhibits similarity crossing a threshold value to a particular positive example pattern or substantial similarity to that pattern, wherein the pattern is specific for an event or state of a bypass valve and/or of valve chatter, then that can be taken as an indication that an occurrence of the event or state of the bypass valve has occurred and/or that valve chatter has occurred.

Similarity and dissimilarity can be measured directly via standard statistical metrics such normalized Z-score, or similar multidimensional distance measures (e.g., Mahalanobis or Bhattacharyya distance metrics), or through similarities of modeled data and machine learning. These techniques can include standard pattern classification methods such as Gaussian mixture models, clustering as well as Bayesian approaches, neural network models, and deep learning, and/or a combination of at least two techniques.

As used herein the term “substantially similar” means that, upon comparison, the sensor data are congruent or have statistics fitting the same statistical model, each with an acceptable degree of confidence. The threshold for the acceptability of a confidence statistic may vary depending upon the filtration system, sensor(s), sensor arrangement, type of data, context, condition, etc.

The statistics associated with the status of a bypass valve over the monitoring time period, can be determined by utilizing any suitable technique or techniques, e.g., standard pattern classification methods such as Gaussian mixture models, clustering, hidden Markov models, as well as Bayesian approaches, neural network models, and deep learning, and/or a combination of at least two techniques.

Various embodiments herein specifically include the application of a machine learning classification model. In various embodiments, the system device can be configured to periodically update the machine learning classification model based on indicators of particular bypass valve events and/or valve chatter. In some embodiments, user input can be used to positively identify particular events and then this information can be used as part of a supervised machine learning approach to positively characterize patterns associated with particular bypass valve events or states or valve chatter. For example, if a bypass valve has opened, a user can input this information into the system and then data corresponding in time with the opening of the valve can be processed in order to generate a pattern that is indicative of valve opening and/or valve chatter.

In some embodiments, a training set of data can be used to generate a machine learning classification model. The input data can include strain data, pressure data, microphone data, temperature, and/or data as described herein as tagged/labeled with binary and/or non-binary classifications of particular bypass valve operational states, operational events, and/or valve chatter. Binary classification approaches can utilize techniques including, but not limited to, logistic regression, k-nearest neighbors, decision trees, support vector machine approaches, naive Bayes techniques, and the like. Multi-class classification approaches (e.g., for non-binary classifications of stress) can include k-nearest neighbors, decision trees, naive Bayes approaches, random forest approaches, and gradient boosting approaches amongst others.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A bypass valve monitoring system comprising:
a control circuit; and
a sensing unit;
wherein the sensing unit generates a signal reflecting high speed pressure and a signal reflecting filter restriction pressure;
wherein the sensing unit is in electronic communication with the control circuit;
wherein the bypass valve monitoring system is configured to
record signals from the sensing unit; and
identify patterns in the signal reflecting high speed pressure associated with filter restriction pressure levels indicating a position of the bypass valve.

2. The bypass valve monitoring system of any of claims 1 and 3-33, the position of the bypass valve comprising at least one selected from the group consisting of fully open, partially open, and fully closed.

3. The bypass valve monitoring system of any of claims 1-2 and 4-33, wherein the bypass valve monitoring system is configured to identify changes in patterns of the signal reflecting high speed pressure associated with filter restriction pressure changes.

4. The bypass valve monitoring system of any of claims 1-3 and 5-33, wherein the bypass valve monitoring system is configured to identify changes in patterns of the signal reflecting high speed pressure associated with filter restriction pressure increases, wherein such changes indicate that a bypass valve has at least partially opened.

5. The bypass valve monitoring system of any of claims 1-4 and 6-33, the patterns comprising frequency patterns.

6. The bypass valve monitoring system of any of claims 1-5 and 7-33, the patterns comprising a multi-band frequency pattern.

7. The bypass valve monitoring system of any of claims 1-6 and 8-33, wherein the bypass valve monitoring system is configured to determine valve opening pressure.

8. The bypass valve monitoring system of any of claims 1-7 and 9-33, wherein the bypass valve monitoring system is configured to determine that the bypass valve is operating in a bypass mode when the filter restriction pressure is above the determined valve opening pressure.

9. The bypass valve monitoring system of any of claims 1-8 and 10-33, wherein the bypass valve monitoring system is configured to track changes in valve opening pressure over time.

10. The bypass valve monitoring system of any of claims 1-9 and 11-33, wherein the bypass valve monitoring system is configured to determine valve opening pressure based on a filter restriction pressure at a time of detected valve opening.

11. The bypass valve monitoring system of any of claims 1-10 and 12-33, wherein the bypass valve monitoring system is configured to estimate filter remaining useful life based on an amount of time that the bypass valve is in an open position.

12. The bypass valve monitoring system of any of claims 1-11 and 13-33, further comprising a temperature sensor, wherein the temperature sensor is in electronic communication with the control circuit and/or wherein the bypass valve monitoring system is configured to receive signals reflecting temperature.

13. The bypass valve monitoring system of any of claims 1-12 and 14-33, wherein the bypass valve monitoring system is configured to distinguish between cold start bypass events and normal operation bypass events based at least in part on a signal from the temperature sensor or a received signal reflecting temperature.

14. The bypass valve monitoring system of any of claims 1-13 and 15-33, wherein the bypass valve monitoring system is configured to utilize signals from a cold start bypass to train the system to detect valve bypass events.

15. The bypass valve monitoring system of any of claims 1-14 and 16-33, wherein the bypass valve monitoring system is configured to estimate filter remaining useful life based on normal operation bypass events.

16. The bypass valve monitoring system of any of claims 1-15 and 17-33, wherein the bypass valve monitoring system is configured to estimate filter remaining useful life based on detected valve opening events.

17. The bypass valve monitoring system of any of claims 1-16 and 18-33, wherein the sensing unit includes a pressure sensor generating both the signal reflecting high speed pressure and the signal reflecting filter restriction pressure.

18. The bypass valve monitoring system of any of claims 1-17 and 19-33, wherein at least a portion of the sensing unit is configured to be in direct contact with a fluid inside a fluid line.

19. The bypass valve monitoring system of any of claims 1-18 and 20-33, wherein the sensing unit is configured to be mounted on a fluid line, but not in direct contact with a fluid inside the fluid line.

20. The bypass valve monitoring system of any of claims 1-19 and 21-33, wherein the sensing unit is configured to be wrapped around a fluid line.

21. The bypass valve monitoring system of any of claims 1-20 and 22-33, the sensing unit comprising a flexible substrate.

22. The bypass valve monitoring system of any of claims 1-21 and 23-33, the sensing unit further comprising two or more sensing elements, wherein the two or more sensing elements are disposed on the flexible substrate.

23. The bypass valve monitoring system of any of claims 1-22 and 24-33, wherein the two or more sensing elements are positioned to be at different axial and/or radial positions along a fluid line.

24. The bypass valve monitoring system of any of claims 1-23 and 25-33, the sensing unit comprising:
a first sensor, wherein the first sensor generates the signal reflecting high speed pressure; and
a second sensor, wherein the second sensor generates the signal reflecting filter restriction pressure.

25. The bypass valve monitoring system of any of claims 1-24 and 26-33, the first sensor comprising a pressure sensor, wherein the pressure sensor has a sampling rate of at least 8,000 Hz.

26. The bypass valve monitoring system of any of claims 1-25 and 27-33, the first sensor comprising a microphone.

27. The bypass valve monitoring system of any of claims 1-26 and 28-33, the second sensor comprising a differential pressure sensor.

28. The bypass valve monitoring system of any of claims 1-27 and 29-33, the second sensor comprising a first pressure sensing element located on one side of a filter element and a second pressure sensing element located on the other side of the filter element.

29. The bypass valve monitoring system of any of claims 1-28 and 30-33, the second sensor comprising a first pressure sensing element located upstream of a filter element and a second pressure sensing element located downstream of the filter element.

30. The bypass valve monitoring system of any of claims 1-29 and 31-33, wherein the bypass valve monitoring system is a liquid filtration bypass valve monitoring system.

31. The bypass valve monitoring system of any of claims 1-30 and 32-33, wherein the bypass valve monitoring system is a hydraulic fluid filtration bypass valve monitoring system.

32. The bypass valve monitoring system of any of claims 1-31 and 33, wherein the bypass valve monitoring system is a gas filtration bypass valve monitoring system.

33. The bypass valve monitoring system of any of claims 1-32, wherein the bypass valve monitoring system is an air filtration bypass valve monitoring system.

34. A method of detecting bypass valve opening comprising:
recording signals from a sensing unit, the signals comprising
a signal reflecting high speed pressure; and
a signal reflecting filter restriction pressure; and
identifying patterns associated with filter restriction pressure levels indicating a position of the bypass valve.

35. The method of any of claims 34 and 36-44, further comprising identifying changes in signal patterns of the signal reflecting high speed pressure associated with filter restriction pressure changes.

36. The method of any of claims 34-35 and 37-44, further comprising identifying changes in signal patterns of the signal reflecting high speed pressure associated with filter restriction pressure increases, wherein such changes indicate that a bypass valve has at least partially opened.

37. The method of any of claims 34-36 and 38-44, further comprising determining valve opening pressure.

38. The method of any of claims 34-37 and 39-44, further comprising determining that the bypass valve is operating in a bypass mode when the filter restriction pressure is above the determined valve opening pressure.

39. The method of any of claims 34-38 and 40-44, further comprising tracking changes in valve opening pressure over time.

40. The method of any of claims 34-39 and 41-44, further comprising determining valve opening pressure based on a filter restriction pressure at a time of detected valve opening.

41. The method of any of claims 34-40 and 42-44, further comprising distinguishing between a cold start bypass event and a normal operation bypass event based at least in part on a signal from a temperature sensor.

42. The method of any of claims 34-41 and 43-44, further comprising estimating filter remaining useful life based on detected normal operation bypass events.

43. The method of any of claims 34-42 and 44, further comprising estimating filter remaining useful life based on an amount of time that the bypass valve is in an open position during normal operation bypass events.

44. The method of any of claims 34-43, further comprising utilizing signals from a cold start bypass to train the system to detect a valve bypass event.

45. A bypass valve monitoring system comprising:
a control circuit;
a first pressure sensor, wherein the first pressure sensor is in electronic communication with the control circuit; and
a second pressure sensor;
wherein the second pressure sensor is in electronic communication with the control circuit;
wherein the second pressure sensor is disposed on an opposite flow side of the valve being monitored from the first pressure sensor;
wherein the bypass valve monitoring system is configured to
evaluate a time domain differential pressure based on signals of the two pressure sensors; and
identify patterns in the time domain differential pressure indicating that a bypass valve has at least partially opened.

46. The bypass valve monitoring system of any of claims 45 and 47-59, wherein the bypass valve monitoring system is configured to identify patterns in the time domain differential pressure associated with pressure changes indicating that a bypass valve is at least partially open.

47. The bypass valve monitoring system of any of claims 45-46 and 48-59, wherein the bypass valve monitoring system is configured to identify changes in time domain differential pressure signal patterns occurring as differential pressure increases, wherein such changes indicate that a bypass valve has at least partially opened.

48. The bypass valve monitoring system of any of claims 45-47 and 49-59, the patterns comprising frequency domain patterns.

49. The bypass valve monitoring system of any of claims 45-48 and 50-59, wherein the bypass valve monitoring system is configured to estimate bypass valve opening pressure.

50. The bypass valve monitoring system of any of claims 45-49 and 51-59, further comprising a temperature sensor, wherein the temperature sensor is in electronic communication with the control circuit and/or wherein the bypass valve monitoring system is configured to receive a signal reflecting temperature.

51. The bypass valve monitoring system of any of claims 45-50 and 52-59, wherein the bypass valve monitoring system is configured to distinguish between cold start bypass events and normal operation bypass events based at least in part on a signal from the temperature sensor or a received signal reflecting temperature.

52. The bypass valve monitoring system of any of claims 45-51 and 53-59, wherein the control circuit is configured to utilize signals from a cold start bypass event to train the system to detect a valve bypass event.

53. The bypass valve monitoring system of any of claims 45-52 and 54-59, wherein the bypass valve monitoring system is configured to estimate filter remaining useful life based on normal operation bypass events.

54. The bypass valve monitoring system of any of claims 45-53 and 55-59, wherein the bypass valve monitoring system is configured to estimate filter remaining useful life based on an amount of time that the bypass valve is in an open position during normal operation bypass events.

55. The bypass valve monitoring system of any of claims 45-54 and 56-59, wherein the first pressure sensor has a sampling rate of at least 8,000 Hz.

56. The bypass valve monitoring system of any of claims 45-55 and 57-59, wherein the second pressure sensor has a sampling rate of at least 8,000 Hz.

57. The bypass valve monitoring system of any of claims 45-56 and 58-59, wherein at least a portion of the first pressure sensor or the second pressure sensor is configured to be in direct contact with a fluid inside a fluid line.

58. The bypass valve monitoring system of any of claims 45-57 and 59, wherein the first pressure sensor and the second pressure sensor are configured to be mounted on a fluid line, but not in direct contact with a fluid inside the fluid line.

59. The bypass valve monitoring system of any of claims 45-58, wherein the first pressure sensor and the second pressure sensor are configured to be mounted on flexible substrates and wrapped around a fluid line.

60. A bypass valve monitoring system comprising:
a control circuit; and
a sensing unit;
wherein the sensing unit is in electronic communication with the control circuit;
wherein the sensing unit generates a signal reflecting acoustics and/or vibrations and a signal reflecting strain;
wherein the bypass valve monitoring system is configured to
record signals from the sensing unit; and
identify patterns associated with the signal reflecting acoustics and/or vibrations reflecting valve chatter and then use correlated values of strain from the signal reflecting strain to determine a bypass valve opening state.

61. The bypass valve monitoring system of any of claims 60 and 62-82, wherein the bypass valve monitoring system is configured to identify patterns of the signal reflecting acoustics and/or vibrations indicating valve chatter associated with strain changes.

62. The bypass valve monitoring system of any of claims 60-61 and 63-82, wherein the bypass valve monitoring system is configured to identify patterns of the signal reflecting acoustics and/or vibrations indicating valve chatter associated with strain increases, wherein such occurrences indicate that a bypass valve has at least partially opened.

63. The bypass valve monitoring system of any of claims 60-62 and 64-82, wherein the bypass valve monitoring system is configured to estimate filter remaining useful life based on an amount of time that the bypass valve is in an open position.

64. The bypass valve monitoring system of any of claims 60-63 and 65-82, the sensing unit comprising a temperature sensor, wherein the temperature sensor is in electronic communication with the control circuit and/or wherein the bypass valve monitoring system is configured to receive signals reflecting temperature.

65. The bypass valve monitoring system of any of claims 60-64 and 66-82, wherein the bypass valve monitoring system is configured to distinguish between cold start bypass events and normal operation bypass events based at least in part on a signal from the temperature sensor or a received signal reflecting temperature.

66. The bypass valve monitoring system of any of claims 60-65 and 67-82, wherein the bypass valve monitoring system is configured to estimate filter remaining useful life based on normal operation bypass events.

67. The bypass valve monitoring system of any of claims 60-66 and 68-82, wherein the bypass valve monitoring system is configured to estimate filter remaining useful life based on detected valve opening events.

68. The bypass valve monitoring system of any of claims 60-67 and 69-82, wherein the sensing unit includes a strain sensing element generating the signal reflecting strain.

69. The bypass valve monitoring system of any of claims 60-68 and 70-82, wherein the sensing unit includes a strain sensing element generating both the signal reflecting strain and the signal reflecting acoustics and/or vibrations.

70. The bypass valve monitoring system of any of claims 60-69 and 71-82, wherein the sensing unit includes a first strain sensing element and a second strain sensing element generating the signal reflecting strain.

71. The bypass valve monitoring system of any of claims 60-70 and 72-82, wherein the signal reflecting strain reflects differential strain at two points along a fluid line.

72. The bypass valve monitoring system of any of claims 60-71 and 73-82, wherein the sensing unit includes an acoustic and/or vibration sensing element generating the signal reflecting acoustics and/or vibrations.

73. The bypass valve monitoring system of any of claims 60-72 and 74-82, wherein at least a portion of the sensing unit is configured to be in direct contact with a fluid inside a fluid line.

74. The bypass valve monitoring system of any of claims 60-73 and 75-82, wherein the sensing unit is configured to be mounted on a fluid line, but not in direct contact with a fluid inside the fluid line.

75. The bypass valve monitoring system of any of claims 60-74 and 76-82, wherein at least part of the sensing unit is configured to be wrapped around a fluid line.

76. The bypass valve monitoring system of any of claims 60-75 and 77-82, the sensing unit comprising a flexible substrate.

77. The bypass valve monitoring system of any of claims 60-76 and 78-82, the sensing unit further comprising two or more sensing elements, wherein the two or more sensing elements are disposed on the flexible substrate.

78. The bypass valve monitoring system of any of claims 60-77 and 79-82, wherein the two or more sensing elements are positioned to be at different axial and/or radial positions along a fluid line.

79. The bypass valve monitoring system of any of claims 60-78 and 80-82, wherein the bypass valve monitoring system is a liquid filtration bypass valve monitoring system.

80. The bypass valve monitoring system of any of claims 60-79 and 81-82, wherein the bypass valve monitoring system is a hydraulic fluid filtration bypass valve monitoring system.

81. The bypass valve monitoring system of any of claims 60-80 and 82, wherein the bypass valve monitoring system is a gas filtration bypass valve monitoring system.

82. The bypass valve monitoring system of any of claims 60-81, wherein the bypass valve monitoring system is an air filtration bypass valve monitoring system.

83. A method of detecting bypass valve opening comprising:
recording signals from a sensing unit, the signals comprising
a signal reflecting acoustics and/or vibrations; and
a signal reflecting strain; and
identifying patterns associated with the signal reflecting acoustics and/or vibrations reflecting valve chatter and then using correlated values of strain from the signal reflecting strain to determine a bypass valve opening state.

84. The method of any of claims 83 and 85-92, further comprising identifying changes in signal patterns of the signal reflecting acoustics and/or vibrations associated with strain value changes.

85. The method of any of claims 83-84 and 86-92, further comprising identifying changes in signal patterns of the signal reflecting acoustics and/or vibrations associated with strain value increases, wherein such changes indicate that a bypass valve has at least partially opened.

86. The method of any of claims 83-85 and 87-92, further comprising determining that the bypass valve is operating in a bypass mode when the signals from the acoustic or vibration sensor is consistent with valve chatter and the strain value is above a threshold value.

87. The method of any of claims 83-86 and 88-92, further comprising distinguishing between a cold start bypass event and a normal operation bypass event based at least in part on a signal from a temperature sensor.

88. The method of any of claims 83-87 and 89-92, further comprising estimating filter remaining useful life based on detected normal operation bypass events.

89. The method of any of claims 83-88 and 90-92, further comprising estimating filter remaining useful life based on an amount of time that the bypass valve is in an open position during normal operation bypass events.

90. The method of any of claims 83-89 and 91-92, wherein the sensing unit includes a first sensing element to generate the signal reflecting acoustics and/or vibrations and a second sensing element to generate the signal reflecting strain.

91. The method of any of claims 83-90 and 92, further comprising wrapping the sensing unit around a fluid line.

92. The method of any of claims 83-91, wherein the sensing unit includes sensing elements that do not directly contact a fluid within a fluid line.
